(19) United States
(12) Patent Application Publication
(10) Pub. No.: US 2004/0054664 A1
(43) Pub. Date: Mar. 18, 2004

(54) Methods for facilitating extensions of computer calculations

(75) Inventor: David P. Fan, St. Paul, MN (US)

Correspondence Address: SCHWEGMAN, LUNDBERG, WOESSNER & KLUTH, P.A., P.O. BOX 2938, MINNEAPOLIS, MN, 55402, US

(73) Assignee: InfoTrend, Inc.

(21) Appl. No.: 10/245,856

(22) Filed: Sep. 17, 2002

(51) Int. Cl. G06F 7/00

(52) U.S. Cl. 707/3

(57) ABSTRACT

Disclosed herein is a method to perform the method for use in an automated text scoring process, wherein a selection collection with general specifications which stay invariant from run to run is provided, and one or more detailed specifications which are changed from run to run are also provided.

### RELATED APPLICATIONS

This application claims priority to and incorporates by reference U.S. Pat. No. 4,930,077, issued May 29, 1980, entitled INFORMATION PROCESSING EXPERT SYSTEM FOR TEXT ANALYSIS AND PREDICTING PUBLIC OPINION BASED INFORMATION AVAILABLE TO THE PUBLIC; and U.S. application Ser. No. 09/563,629, filed May 2, 2000, entitled METHODS FOR ENHANCING DYNAMIC MENUS AND TEXTUAL ANALYSIS.

### TECHNICAL FIELD

The technical field relates generally to the field of automated text scoring and opinion prediction.

### COPYRIGHT NOTICE—PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent files or records, but otherwise reserves all copyright rights whatsoever. The following notice applies to the software and data as described below and in the drawings attached hereto: Copyright © 2002, David P. Fan, All Rights Reserved.

### BACKGROUND

Systems are available for using input persuasive information to compute predictions of public opinions and other population traits such as public knowledge, attitudes and behaviors. An example of a public opinion is the percent of the population favoring a particular candidate in a political election. An example of a prediction is a time trend of a population trait. An example of input persuasive information is text from newspaper stories.

In many instances, a computer is used to compute a prediction of a public opinion from some time in the past up to the present time. Then, as time proceeds, the computation is extended to a later time using input text data which became available after the ending time of the last computation. In elections, for instance, such computations can be extended daily or weekly. For such extensions, the user uses a common set of computer instructions with minor changes such as changes in the beginning and ending times of the input text data. The present invention facilitates the extensions by providing an improved system for changing the computer instructions for the extensions. In past implementations, modified computer instructions were written manually.

### BRIEF DESCRIPTION OF THE DRAWINGS

FIG. 1 is a block diagram of a system according to one aspect of the present invention.

FIG. 2 is a structure diagram of a system according to one aspect of the present invention.

FIG. 3 is a structure diagram of a flow logic structure according to one aspect of the present invention.

FIG. 4 is a structure diagram of a task structure according to one aspect of the present invention.

FIG. 5 is a flow diagram of a system according to one aspect of the present invention.

FIG. 6 is a structure diagram of a storage structure according to one aspect of the present invention.

FIG. 7 is a structure diagram of a retrieving directory structure according to one aspect of the present invention.

FIG. 8 is a structure diagram of a collection script file structure according to one aspect of the present invention.

FIG. 9 is a structure diagram of a project collection script file fragment structure according to one exemplary embodiment of the present invention.

FIG. 10 is a structure diagram of a selection collection script file fragment structure according to one exemplary embodiment of the present invention.

FIG. 11 is a structure diagram of a detailed retrieving specification file fragment structure according to one exemplary embodiment of the present invention.

FIG. 12 is a structure diagram of a detailed retrieving specification file fragment structure according to one exemplary embodiment of the present invention.

### DETAILED DESCRIPTION

In the following detailed description of exemplary embodiments of the invention, reference is made to the accompanying drawings that form a part hereof, and in which is shown, by way of illustration, specific exemplary embodiments in which the invention may be practiced. In the drawings, like numerals describe substantially similar components throughout the several views. These embodiments are described in sufficient detail to enable those skilled in the art to practice the invention. Other embodiments may be utilized and structural, logical, electrical, and other changes may be made without departing from the spirit or scope of the present invention. The following detailed description is, therefore, not to be taken in a limiting sense, and the scope of the present invention is defined only by the appended claims.

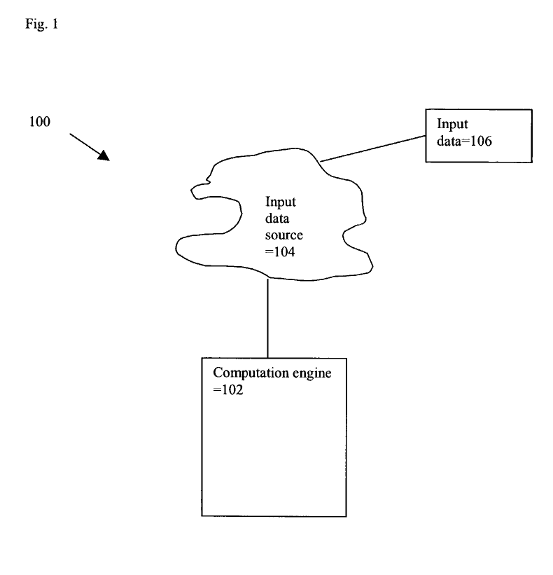

FIG. 1 is a block diagram of a system according to one aspect of the present invention. A system 100 includes a computation engine 102. The computation engine 102 includes software for a multiple task computer system. Until the discussion below on alternate embodiments, the multiple task computer system will refer to one used for predicting public opinion time trends from input data 106.

In one implementation input data 106 is in the form of text. The computation engine 102 is adapted to interface an input data source 104 so as to allow access to input data 106. In one implementation, an input data source is the World Wide Web.

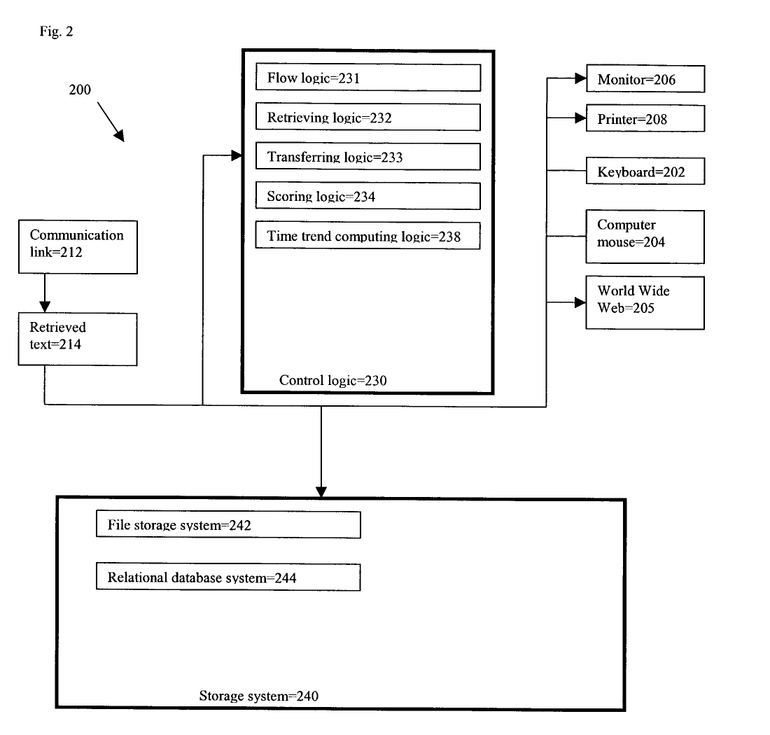

FIG. 2 is a block diagram of a system according to one aspect of the present invention. A system 200 according to FIG. 2 is designed to use data in the form of retrieved text 214 as the input for a multiple task computer system. In one embodiment, the World Wide Web 205 is accessed through communication link 212 to obtain retrieved text 214. The user communicates with the computer through a keyboard 202, a computer mouse 204, a monitor 206, or a printer 208.

The system 200 includes a storage system 240. In one implementation, a storage system 240 includes a file storage system 242. In one implementation, a storage system 240 includes a relational database system 244.

The system 200 includes a control logic 230 to control a multiple task computer system.

In one implementation, control logic 230 is specified by text scripts stored in a file storage system 242. In one implementation, control logic 230 controls a at least one task. In one implementation, control logic 230 includes one or more of the following logics:

a retrieving logic 232 controlling the task of retrieving text and storing the retrieved text in a file storage system,

a transferring logic 233 controlling the task of transferring retrieved text stored in a file storage system to a relational database system,

a scoring logic 234 controlling the task of generating numerical scores corresponding to retrieved text 214,

a time trend computing logic 238 controlling the task of computing a time trend of public opinion from scores generated using scoring logic 234,

a flow logic 231 controlling tasks corresponding to the logics of control logic 230.

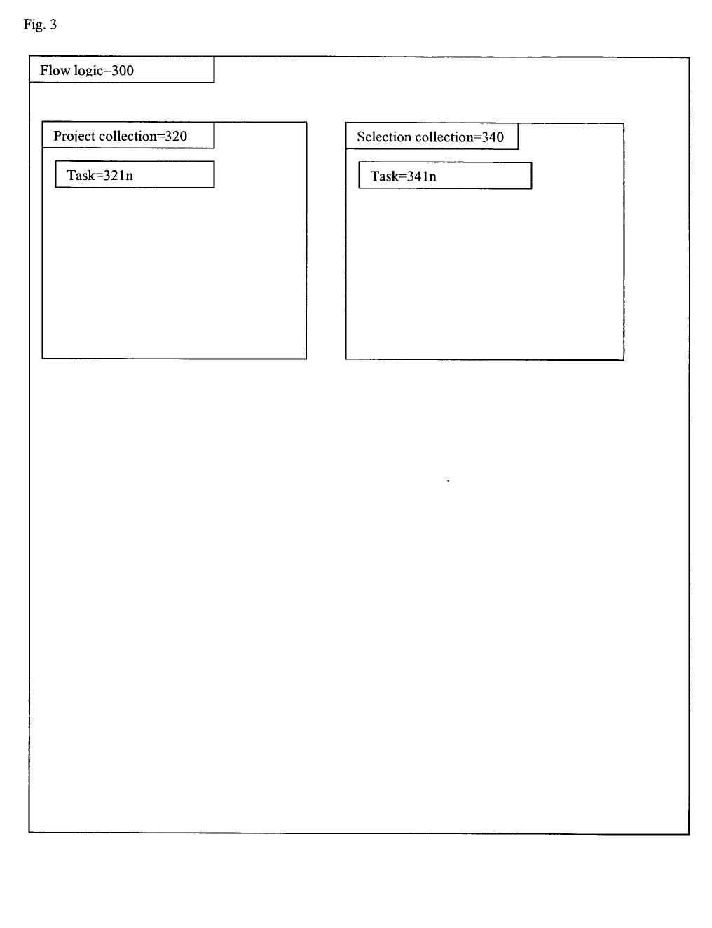

FIG. 3 is a structure diagram of a logic structure according to one embodiment of the present invention. A flow logic structure 300 according to FIG. 3 is designed to control at least one task. In one implementation, flow logic structure 300 includes a project collection member 320 to provide specifications for a set of computer tasks of a multiple task computer system.

In one implementation, a project collection member 320 includes at least one task member 321n controlling a task in a multiple task computer system.

In one implementation, flow logic structure 300 includes a selection collection member 340. In one implementation, a selection collection member 340 includes at least one task member 341n controlling a task in a multiple task computer system.

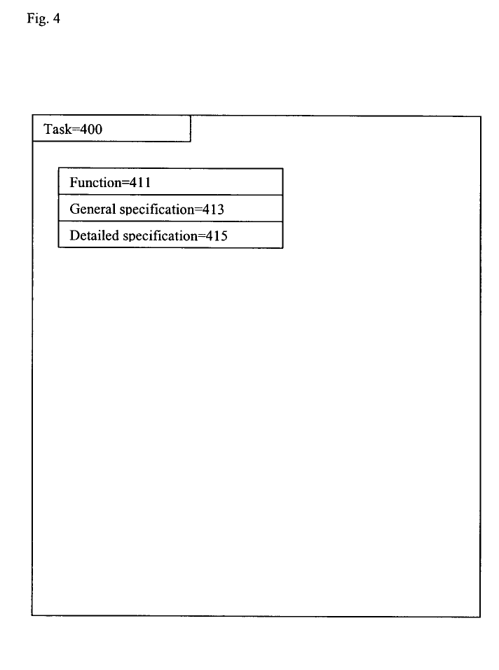

FIG. 4 is a structure diagram of a task structure according to one embodiment of the present invention. A task structure 400 according to FIG. 4 is designed for controlling tasks. In one implementation, task structure 400 includes one or more of a group of members:

a function descriptor member 411 specifying a task being controlled,

a general specification member 413 providing a subset of the specifications used in performing a task, and

detailed specification member 415 providing a subset of the specifications used in performing a task.

In one implementation, a specification in a general specification member overrides a specification in a detailed specification member.

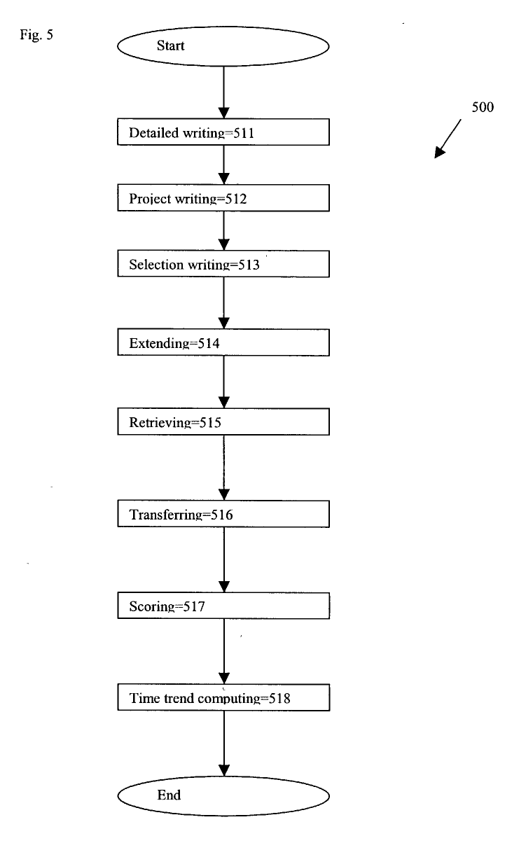

FIG. 5 is a process diagram of a method according to one aspect of the present invention. A process 500 discusses a method for a multiple task computer system. The process 500 includes a number of acts:

an act detailed writing 511 for writing a detailed specification for a task,

an act project writing 512 for writing a project collection,

an act selection writing 513 for writing a selection collection,

an act extending 514 for generating specifications which are minor variants of existing specifications for tasks of prior computer runs,

an act retrieving 515 corresponding to the task of retrieving text and storing the retrieved text in a file storage system,

an act transferring 516 corresponding to the task of transferring retrieved text stored in a file storage system to a relational database system,

an act scoring 517 corresponding to the task of generating numerical scores corresponding to retrieved text,

an act time trend computing 518 corresponding to the task of computing a time trend of public opinion from numerical scores generated from retrieved text.

In one implementation, the results of an act of process 500 are stored in a file storage system for later use. In one implementation, an act of process 500 includes the user responding to a menu item, a prompt or a template provided by the computer.

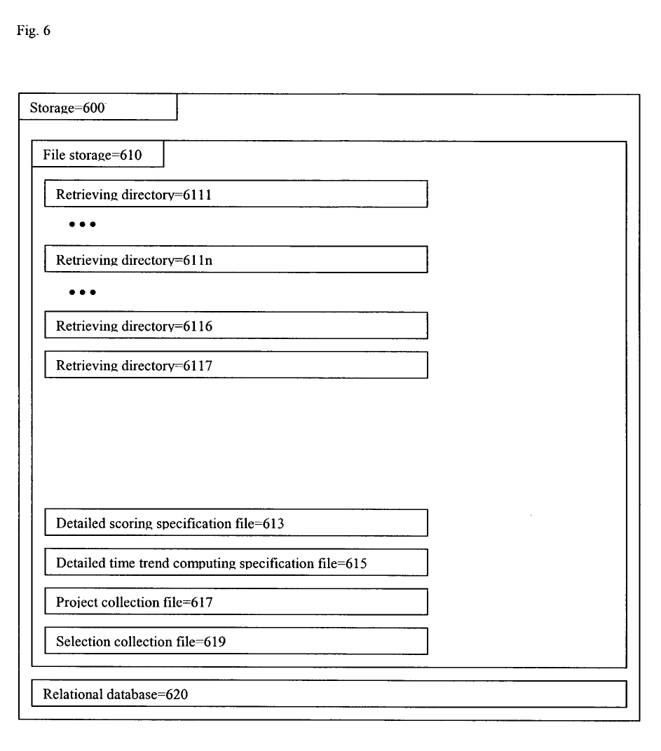

FIG. 6 is a structure diagram of a storage structure according to one embodiment of the present invention. A storage structure 600 according to FIG. 6 is designed for an opinion predicting system. In one implementation, storage structure 600 includes a group of members:

a file storage member 610 specifying a file structure for storing detailed specifications for one or more tasks of a multiple task computer system and for storing text obtained by an act retrieving, and

a relational database system member 620 for storing the results of an act transferring and of other acts in a multiple task computer system.

In one implementation, a file storage member 610 includes a group of members:

a retrieving directory member 61 In specifying at least one directory indexed by n for files of an act retrieving (FIG. 6 shows a series of retrieving directory members 611n beginning with 6111, and ending with 6116 and 6117),

a detailed scoring specification file member 613 specifying a file for storing a detailed specification for an act scoring,

a detailed time trend computing specification file member 615 specifying a file for storing a detailed specification for an act time trend computing,

a project collection file member 617 specifying a file for storing a project collection, and

a selection collection file member 619 specifying a file for storing a selection collection.

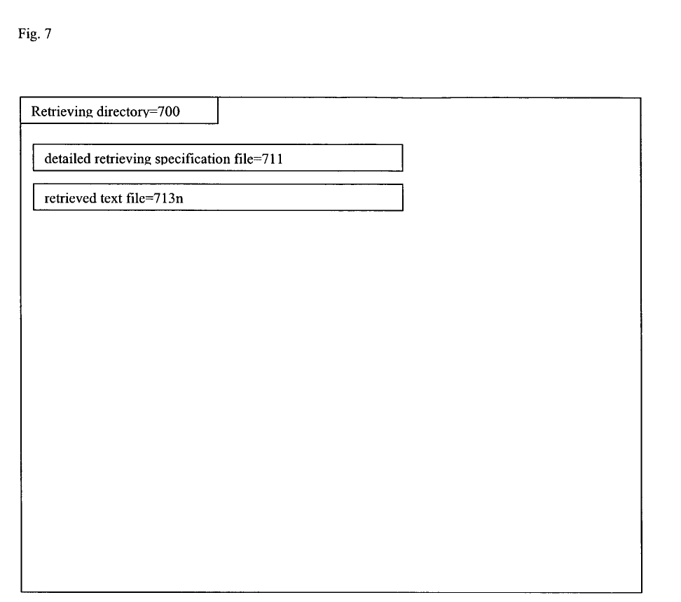

FIG. 7 is a structure diagram of a directory structure according to one embodiment of the present invention. A retrieving directory structure 700 according to FIG. 7 is designed for a retrieving directory. In one implementation, retrieving directory structure 700 includes a group of members:

a detailed retrieving specification file member 713 specifying a file for storing a detailed specification for an act retrieving, and

a retrieved text file member 715 specifying at least one file for storing retrieved text obtained from the World Wide Web.

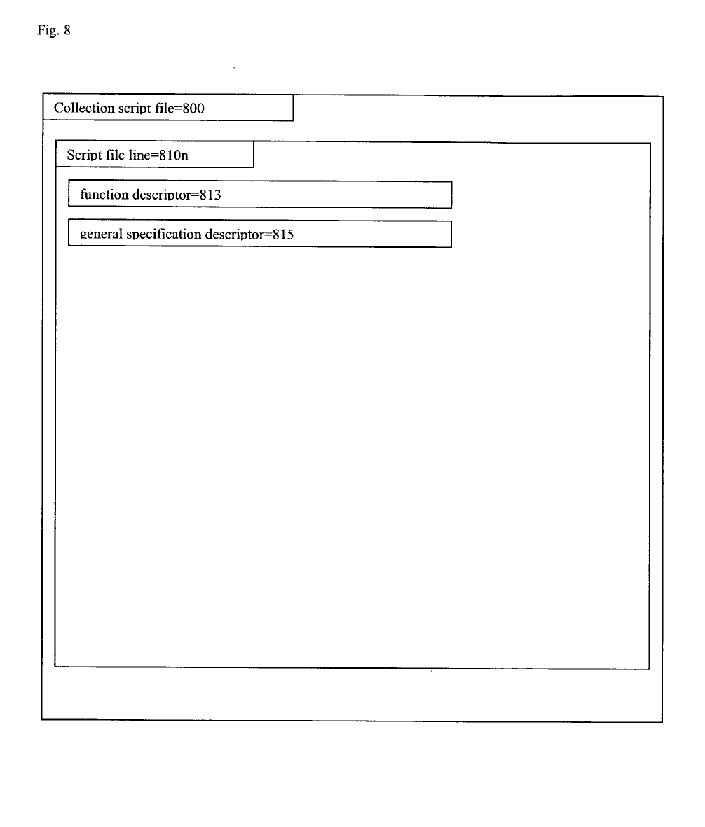

FIG. 8 is a structure diagram of a collection script file structure according to one embodiment of the present invention. A collection script file structure 800 according to FIG. 8 is designed for a project collection or a selection collection. In one implementation, collection script file structure 800 includes one or more script file line members 810n wherein each script file member specifies a task. In one implementation, script file line member 81 On includes:

a function descriptor member 813 specifying a function of a task and situated as the second to the left most entry of a script file line member 81 On, and

a general specification descriptor member 815 specifying a general specification of a task and situated as the remainder of a script file line member 810n.

In one implementation, each script file line member 810n is indexed by a number at the extreme left of the script file line for convenience of reference.

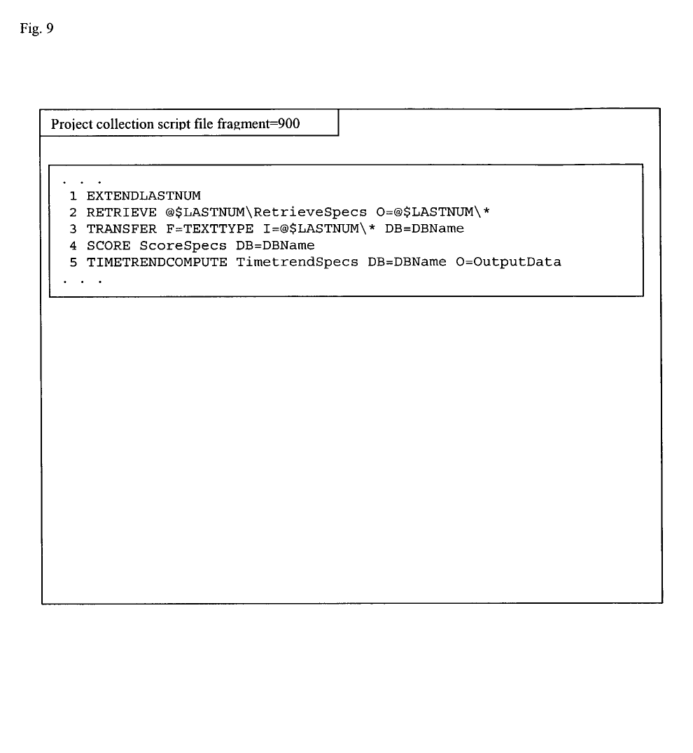

FIG. 9 is a fragment of a script file according to one embodiment of the present invention. A project collection script file fragment 900 according to FIG. 9 is designed for a project collection. In one implementation, project collection script file fragment 900 includes one or more script file line members using a collection script file structure. Script file lines from top to bottom correspond to a number of tasks:

Task 1 includes a function descriptor EXTENDLASTNUM specifying an act extending including generating at least one detailed specification.

Task 2 includes a function descriptor RETRIEVE specifying an act retrieving including retrieving text from the World Wide Web and storing the retrieved text in a retrieved text file in a retrieving directory. All entries to the right of term RETRIEVE constitute a general specification. Among these entries:

entry @$LASTNUM\RetrieveSpecs specifies that a detailed retrieving specification for an act retrieving is stored in a detailed retrieving specification file called RetrieveSpecs in a retrieving directory specified by extending token @$LASTNUM (An extending token is used in an act extending. In an exemplary implementation, extending token @$LASTNUM refers to @$7 in a series of retrieving directories @$1 . . . @$6,@$7 wherein 7 indexes the retrieving directory with the beginning and ending times of the most recent retrieved text.), and

entry O=@$LASTNUM\* specifies that retrieved text is to be placed in at least one file in the same retrieving directory @$7.

Task 3 includes a function descriptor TRANSFER specifying an act transferring for transferring retrieved text from a retrieved text file to a relational database system. All entries to the right of term TRANSFER constitute a general specification. Among these entries:

entry I=@$LASTNUM\* specifies that an act transferring transfers retrieved text from the retrieving directory @$7,

entry DB=DBName specifies the relational database system receiving the results of an act transferring, and

entry F=TEXTTYPE specifies the detailed specification for an act transferring since retrieved text from different World Wide Web sources are in different formats.

Task 4 includes a function descriptor SCORE specifying an act scoring including generating scores from retrieved text in a relational database system. All entries to the right of term SCORE constitute a general specification. Among these entries:

entry ScoreSpecs specifies that a detailed specification for an act scoring is stored in a detailed scoring specification file ScoreSpecs, and

entry DB=DBName specifies a relational database system containing retrieved text to be scored.

Task 5 includes a function descriptor TIMETRENDCOMPUTE specifying an act time trend computing including generating a time trend of a public opinion from scores in a relational database system. All entries to the right of term TIMETRENDCOMPUTE constitute a general specification. Among these entries:

entry TimetrendSpecs specifies that a detailed specification for an act time trend computing is stored in a detailed time trend computing specification file TimetrendSpecs, and

entry DB=DBName specifies a relational database system containing scores used in an act time trend computing.

In one embodiment, the user only performs a subset of the tasks in a project collection. In one implementation, the user performs an act selection writing to select a desired subset of tasks. To do so, the user clicks a menu item specifying an act selection writing, and the computer presents the user with a project collection in the form of a list of numbered script file lines from a project collection file. The user selects desired script file lines, and the computer copies the selected script file lines from a project collection file to a selection collection file.

An act selection writing is not limited to verbatim copying. Changes can be made. In one implementation, the computer asks if the user wishes to score all the retrieved text in a relational database system or just a subset. In one embodiment, the user chooses just the most recent retrieved text, and the computer adds the running token LASTRETRIEVALS=1 to the SCORE script file line as part of a general specification of the selection collection file. A running token is used during the running of a task.

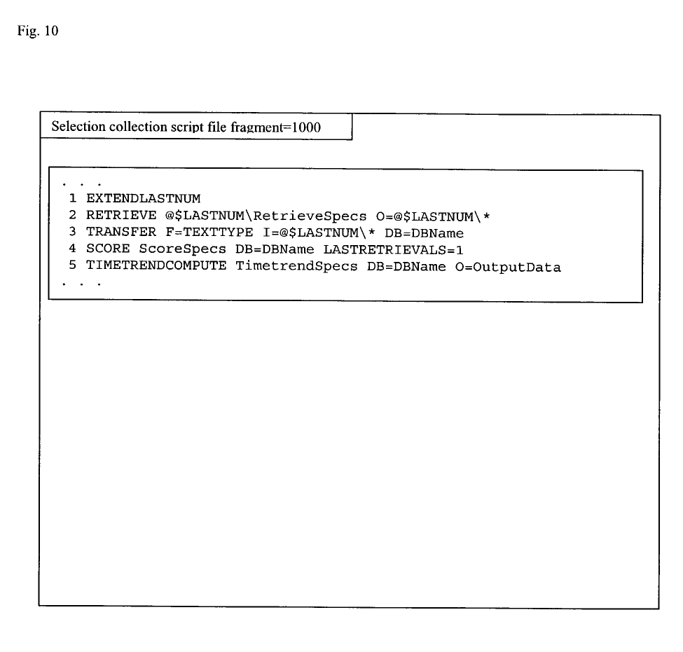

In one embodiment, the user performs an act selection writing by selecting all script file lines in the project collection fragment of FIG. 9. The resulting selection collection file fragment is shown in FIG. 10 and has the same script file lines with the addition of the running token LASTRETRIEVALS=1 to selection collection file line 4.

In one embodiment, the user extends the analysis to a later time interval by clicking an item on the computer screen to instruct the computer to run all the tasks specified in the selection collection file fragment of FIG. 10. The computer runs all tasks in sequence, waiting for one task to finish before beginning the next:

Task 1 is EXTENDLASTNUM including an act extending. In an act extending, the computer looks up the name of the last @$n directory and then increments n by 1 so if the old n was 6, then the incremented n is 7. The computer now replaces, in working memory all @$LASTNUM tokens in the selection collection by @$7. No changes are made to the selection collection file.

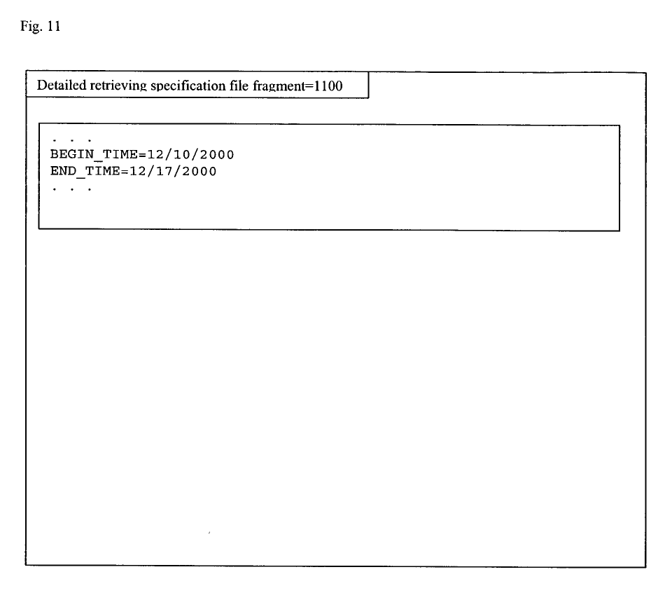

Upon seeing @$LASTNUM in script file line 2 in a selection collection file, the computer creates a directory @$7. The computer copies detailed retrieving specification file RetrieveSpecs from directory @$6 to @$7 to give a new detailed retrieving specification file @$7\RetrieveSpecs. The computer opens file @$7\RetrieveSpecs and looks in file @$7\RetrieveSpecs for the beginning and ending times of the retrieved text. A detailed retrieving specification file fragment with these times is shown in FIG. 11. The beginning time is the date 12/10/2000 indicated by the entry BEGIN_TIME=12/10/2000. The ending time is the date 12/17/2000 indicated by the entry END_TIME=12/17/2000.

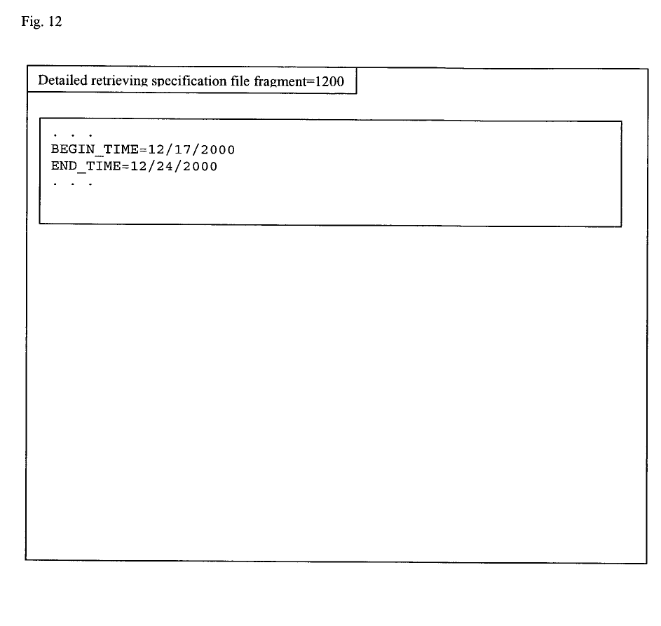

Since detailed retrieving specification file @$7\RetrieveSpecs is an exact copy of detailed retrieving specification file @$6\RetrieveSpecs, the two files have the same beginning and ending times. The computer converts the ending time to the beginning time of detailed retrieving specification file @$7\RetrieveSpecs. The computer looks up the current time and asks the user if the user wishes to use the current time as the new ending time of the retrieval. At this point, the user can either choose the current time or enter another time. The computer writes the new ending time selected by the user to @$7\RetrieveSpecs to give a replacement detailed retrieving specification file fragment (FIG. 12). In this way, detailed retrieving specification files RetrieveSpecs in directories @$6 and @$7 are only different in their beginning and ending times with the ending time of file in @$6\RetrieveSpecs corresponding to the beginning time in file @$7\RetrieveSpecs. As a result, an act retrieving using @$6\RetrieveSpecs followed by an act retrieving using @$7\RetrieveSpecs results in a continuous set of retrieved text with no overlap. In one implementation, the times can be purposely set to overlap with the computer instructed to remove the overlap text from the database.

Once the computer has performed an act extending including the steps given above, the computer exits task 1 and proceeds to task 2, an act retrieving including using detailed retrieving specification file @$7\RetrieveSpecs and storing the retrieved text in files in the new @$7 directory

The computer proceeds with the other runs in the sequence using any other new detailed specifications created by an act extending. During the running of task 4 corresponding to an act scoring, the computer sees the running token LASTRETRIEVALS=1 and only performs an act scoring on the last retrieval. In one embodiment, the token is LASTRETRIEVALS=3 which would lead the computer to perform an act scoring on the last three retrievals.

In one implementation, an act extending or any other tasks can be performed individually by clicking appropriate items on the computer screen.

In the exemplary embodiment discussed hereinbefore, various modifications can be made without departing from the scope of the present invention. These modifications include:

Alternate extending: In the exemplary embodiment, the computer provides the user with one or more template and hence one or more choice for an act extending. For some purposes, such as updating to the current time, all acts extending can be performed automatically by the computer using predefined conditions without user intervention.

Alternate multiple task computer systems: The exemplary embodiment was for a multiple task computer system for predicting public opinion time trends. In an alternate embodiment, the multiple task computer system is designed to accomplish another set of tasks. This invention can apply equally to any multiple task computer system for which the specifications for tasks are extended by minor modifications of specifications written for prior computer runs.

In the exemplary embodiment, multiple task computer system included more than one task. In an alternate embodiment, the multiple task computer system can include just one task.

Alternate variables: In the exemplary embodiment, the minor modifications made in task specifications to were to change the variables of the beginning and ending dates for retrieving text. In an alternate embodiment, a minor modification can be made to another variable.

Alternate storage systems: In the exemplary embodiment, the storage system included a file storage system and a relational database system. In an alternate embodiment, the storage system can be either of these systems or some other storage system.

Alternate running patterns: In the exemplary embodiment, all tasks were run in a fixed sequence. In an alternate embodiment, one or more tasks can be run simultaneously. In an alternate embodiment, the running sequence is not fixed.

According to yet another embodiment the foregoing embodiments may be combined with and used in connection with the subject matter and embodiments shown in the application and patent incorporated by reference herein above.

### Conclusion

Systems, methods, and structures have been discussed to extending specifications for multiple task computer systems. Various embodiments of the present invention use a project collection of tasks for a wide variety of analyses. The user can select a particular subset of all tasks in a project collection for a selection collection for a particular set of repeated computer runs made with minor variations in the specifications of the tasks. The present invention provides a convenient way to make these minor variations with a reduced user input. The result is that it is easier to make repeated computer runs with minor modifications in task specifications.

I claim:

1. A method for use in an automated text scoring process comprising:
a selection collection with general specifications which stay invariant from run to run; and
one or more detailed specifications which are changed from run to run.

2. The method of claim 1, wherein the selection collection is obtained from a project collection.

3. The method of claim 1, wherein the method makes minor modifications to task specifications.

4. The method of claim 3, wherein the method makes use of extending tokens.

5. The method of claim 1, wherein the method is specified in a selection collection.

6. The method of claim 1, wherein the user specifies the method by clicking an item on a computer screen.

7. The method of claim 2, wherein the method is specified in a project collection.

8. The method of claim 1, wherein the method specifies a new storage structure.

9. The method of claim 1, wherein the method creates a new storage structure.

10. The method of claim 1, wherein a selection collection is stored as a script file

11. The method of claim 10, wherein a line in the script file specifies a task and includes:
a function of the task;
a general specification for the task; and
a reference to a detailed specification for the task.

12. The method of claim 1, wherein the automated text scoring is used to make a prediction of a population trait.

13. The method of claim 12, wherein a population trait is an opinion, a knowledge, an attitude, or a behavior.

14. The method of claim 12, wherein a prediction is of a time trend.

15. The method of claim 1, wherein a specification in a general specification overrides a specification in a detailed specification.

16. The method of claim 3, wherein the user responds to a menu item provided by a computer for the method.

17. The method of claim 3, wherein the user responds to a template provided by a computer for the method.

18. The method of claim 3, wherein the user responds to a prompt provided by a computer for the method.

19. The method of claim 3, wherein a selection collection is left unchanged after the method.

20. The method of claim 2, wherein a computer presents the user with list of tasks and general specifications corresponding to a project collection for selecting tasks and general specifications for a selection collection.

21. The method of claim 2, wherein a computer presents the user with information useful for modifying a general specification for an act selection writing for generating a selection collection.

22. The method of claim 3, wherein the method includes changing a time specification.

23. The method of claim 22, wherein a changed time specification is derived from a time specification in a detailed specification.

24. The method of claim 3, wherein a changed time specification is derived from the current time.

25. The method of claim 3, wherein a changed time specification is derived from the current time.

26. The method of claim 22, wherein times are specified so that time intervals do not overlap.

27. The method of claim 22, wherein times are specified so that time intervals do overlap with data from an overlap time interval automatically removed by a computer.

28. The method of claim 3, wherein the method is performed without user input.

29. A method to run tasks in an automated text scoring process, wherein running tokens are used.

30. The method of claim 29 wherein the automated text scoring is to make a prediction of a population trait.

31. The method of claim 30 wherein a population trait is an opinion, a knowledge, an attitude, or a behavior.

32. The method of claim 30 wherein a prediction is of a time trend.

33. The method of claim 29, wherein a running token specifies a range of input data for computer tasks.

34. A method to run tasks of an automated text scoring process, wherein tasks specified by a selection collection are run in sequence with one task finishing before the next one begins.

35. A method to run tasks of an automated text scoring process, wherein tasks specified by a selection collection are not run in sequence with one task finishing before the next one begins.
